(19) United States
(12) Patent Application Publication
(10) Pub. No.: US 2006/0045050 A1
(43) Pub. Date: Mar. 2, 2006

(54) Method and system for a quality of service mechanism for a wireless network

(76) Inventors: Andreas Floros, Patras (GR); Theodore Karoubalis, Peiraias (GR)

Correspondence Address: SAWYER LAW GROUP LLP, P O BOX 51418, PALO ALTO, CA, 94303, US

(21) Appl. No.: 10/986,244

(22) Filed: Nov. 10, 2004

(30) Foreign Application Priority Data
Aug. 30, 2004 (GR) 20040100342

(51) Int. Cl. H04Q 7/00

(52) U.S. Cl. 370/332

(57) ABSTRACT

A quality of service mechanism for a wireless network includes providing an admission control policy for a quality of service access point (QAP) to manage bandwidth by accepting or denying service to admitted traffic streams of quality of service stations (QSTAs) Further included is renegotiating different access category parameters in the QAP for enhancing performance in the wireless network. An additional aspect also includes monitoring in the QSTAs for enhanced networking to determine whether bandwidth allocation to a specific access category meets QoS requirements under time-varying network conditions and renegotiating admitted access category bandwidth if necessary.

### FIELD OF THE INVENTION

The present invention relates to wireless communication networks, and more particularly to a quality of service mechanism for allocating and monitoring traffic bandwidth with quality of service guarantees under unpredictable wireless environment conditions.

### BACKGROUND OF THE INVENTION

Wireless communications have merited tremendous growth over the past few years, becoming widely applied to the realm of personal and business computing. Wireless access is quickly broadening network reach by providing convenient and inexpensive access in hard-to-wire locations. A major motivation and benefit from wireless LANs is increased mobility. Wireless network users are able to access LANs from nearly anywhere without being bounded through a conventional wired network connection.

The IEEE 802.11 standard for wireless LANs (WLANs) stands as a significant milestone in the evolution of wireless network technologies. Currently being specified in IEEE 802.11e is a set of quality of service (QoS) enhancements to the medium access control (MAC). For purposes of this discussion, references to the 802.11e specification correspond to IEEE80211 WG, IEEE802.11e/D8.0, “Draft Amendment to Standard for Information Technology—Telecommunications and Information Exchange between Systems—LAN/MAN Specific Requirements—Part 11: Wireless Medium Access Control (MAC) and Physical Layer (PHY) Specifications: Medium Access Control (MAC) Quality of Service (QoS) Enhancements,” February 2004. QoS refers to set of qualitative and quantitative traffic characteristics (e.g. throughput, service interval, packet size, delay, jitter, priority, etc.), which describes a traffic flow in support of a specific application. The developing 802.11e specification introduces a logical function in a quality of service station (QSTA) that determines, under enhanced distributed channel access (EDCA) rules, when a frame in a transmission queue belonging to an associated Access Category (AC) is permitted to be transmitted via the wireless medium. EDCA, a contention-based channel access method, generally provides differentiated, distributed access to the wireless medium using different levels of priorities. EDCA is normally employed by a hybrid coordination function (HCF) within a hybrid coordinator (HC) of a quality of service access point (QAP).

A need exists for enhancement of the EDCA logic function that allows better bandwidth management. A further need exists for enhancing the quality of service performance under unpredictable conditions (e.g., channel degradation, packet bursting, etc.) by renegotiating the traffic stream conditions. The present invention addresses such needs.

### SUMMARY

Aspects for a quality of service mechanism for a wireless network are described. The aspects include providing an admission control policy for a quality of service access point (QAP) to manage bandwidth by accepting or denying service to admitted traffic streams of quality of service stations (QSTAs). Further included is renegotiating different access category parameters in the QAP for enhancing performance in the wireless network. An additional aspect also includes monitoring in the QSTAs for enhanced networking to determine whether bandwidth allocation to a specific access category meets QoS requirements under time-varying network conditions and renegotiating admitted access category bandwidth if necessary.

Through the present invention, better bandwidth management is achieved while introducing very small implementation overhead for quality of service considerations in a wireless network. In addition to producing better bandwidth management, the present invention overcomes unpredictable performance drops in a manner that remains transparent to the rest of the network devices. Further, access points and station client devices of a wireless network are affected in a way that remains fully compatible with the 802.11e specification. These and other advantages of the aspects of the present invention will be more fully understood in conjunction with the following detailed description and accompanying drawings.

### BRIEF DESCRIPTION OF THE DRAWINGS

FIG. 1 illustrates a system diagram of a wireless network in accordance with the present invention.

FIG. 2 illustrates a flow diagram representation of a QSTA monitoring mechanism in accordance with the present invention.

### DETAILED DESCRIPTION

The present invention relates to a quality of service mechanism for monitoring traffic bandwidth and providing quality of service guarantees under unpredictable wireless environment conditions. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiments shown but is to be accorded the widest scope consistent with the principles and features described herein.

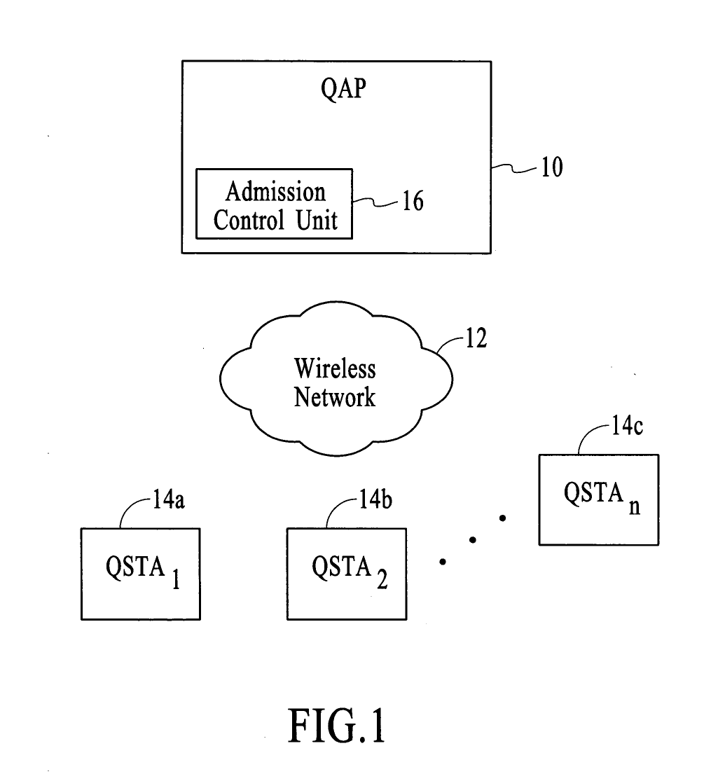

In general, the present invention provides EDCA enhancements that are fully compatible with the 802.11e specification. Referring to FIG. 1, a block diagram representation of a quality of service basic service set (QBSS) is shown. Included in the QBSS are a quality of service access point (QAP) 10 communicating across a wireless network 12 with two (or more) QSTAs 14a, 14b, 14c.

Further included in the QAP 10 is an admission control unit 16 that implements an admission control policy in accordance with the present invention. The admission control policy implements a procedure to define the access categories (ACs) that will require admission control during the QBSS lifecycle. This is performed by setting and announcing the value of the admission control mandatory bit (ACM) for each AC to all participating QSTAs using the EDCA parameter set element. Preferably, only AC_VI and AC_VO (video and voice access categories) require admission control. The admission control policy also implements a procedure to accept, deny, or negotiate a service requested for a traffic stream (TS) upon reception of an AddTS request sent by a non-AP QSTA (where QSTAs create AddTS requests only for TSs that are mapped to ACs that require admission control.)

Thus, in accordance with the present invention, upon reception of a service AddTS request from QSTA 14, the QAP 10 determines whether to accept or deny the requested service based on the calculation of a TSPEC (Traffic Specification) MediumTime Value defined in the 802.11e specification and the calculation of a Medium Occupancy Factor.

Calculation of the TSPEC MediumTime Value

The TSPEC MediumTime value, which represents the time a TS occupies the medium in a 1 second time period, is calculated in accordance with the developing 802.11e specification using the equation:
MediumTime=(SBA)(pps)FrameExchangeTime (1)

In the equation, SBA refers to the TSPEC surplus bandwidth allowance value. FrameExchangeTime is defined as:
FrameExchangeTime=(M*8/PHY)+SIFS+ACKDuration (2)
and thus refers to the time interval, in seconds, required for transmitting a nominal MDSU packet of size M bytes using the minimum PHY rate in bits per second (bps) plus SIFS, in seconds, and the duration of an ACK (acknowledgment) packet, in seconds.

Also for equation (1), pps refers to the number of data packets per second produced by the traffic source and can be calculated by:
pps=MeanDataRate/(M*8) (3)
where MeanDateRate is the TSPEC mean data rate parameter value in bits per second. It should be noted that if packet fragmentation is performed by the MAC layer, the value of M should be set to the single MAC protocol data unit (MPDU) length.
Calculation of the Medium Occupancy Factor

In accordance with the present invention, a variable is defined for the QAP 10 called Medium Occupancy Factor (MOF), expressed in seconds. The MOF value is equal to the summation of all of the MediumTime values of the currently admitted traffic in the current QBSS, i.e.:

$$MOF = ( {\sum }_{i = 1}^{N} {MediumTime}_{1} ) \qquad ( 4 )$$

In equation (4), N is the total number of currently admitted TSPECs. Upon reception of an AddTs request and after the corresponding MediumTime_{N+1} value calculation according to equation (1), a new MOF value if calculated as:
MOF′=MOF+MediumTime_{N+1} (5)

Given that the MediumTime represents the exact amount of time that a TS will occupy for transmissions within a 1 second interval, the requesting TS can be admitted only if the MOF′ value is lower than 1 second. If MOF′ is less than 1 second, the requesting stream can be admitted, and the MOF value is updated, i.e., MOF=MOF′. This condition may be expressed as:

$${MOF}^{′} = ( {\sum }_{i = 1}^{N + 1} {MediumTime}_{1} ) \leq 1 \qquad ( 6 )$$

If MOF′ is not less than 1 second, the service is denied. However, upon rejection, the QAP 10 may suggest alternative TSPEC values (e.g., by alternating the MinimumPHYRate TSPEC parameter value) and initialize a negotiation with the requesting QSTA 14.
Admission Control Criteria

Under certain circumstances, persistent transmission blocking for the TSs (and ACs) that require no admission may result, e.g., when an assumption is made that 100% of the bandwidth occupance is handled by the QAP under the EDCA admission rules. In such a case, it may be necessary to reserve a specific amount of bandwidth occupancy for this traffic, as represented by:

$$MOF = ( {\sum }_{i = 1}^{N + 1} {MediumTime}_{1} ) \leq B \qquad ( 7 )$$

where B<1 (in seconds). This reserves the (1−)*100 (%) of the total available bandwidth for the traffic that requires no admission.

Further, the admission control policy may be extended to a per AC-basis. In such a case, the traffic differentiation represented by the ACs is extended to the available admission capacity. More specifically, the QAP 10 may calculate a per AC MOF value as the aggregation of the medium timers of those TSPECs that are serviced through the same AC with the one that the requesting TSPEC is mapped to. Then, in order to derive the accept/deny response, the resulting MOF[AC] value is compared to the per AC bandwidth allocation limit B[AC], according to:

$$MOF [ A C ] = ( {\sum }_{k = 1}^{K + 1} {MediumTime}_{k} ) \leq B [ A C ] \qquad ( 8 )$$

where K denotes the total number of TSs within the QBSS that are serviced through the specific AC. The value of the per AC bandwidth allocation limit B[AC] must obviously satisfy the following conditions:
0≦B[AC]≦1 (9)
and

$${\sum }_{1} B [ i ] \leq B \qquad ( 10 )$$

where i is the index of the ACs that require admission control.
QAP Admission Control Policy with TSPEC Negotiation

In accordance with the present invention, a mechanism is provided that allows acceptance of an otherwise rejected (from the admission control unit) traffic stream. More specifically, upon an AddTS request that would normally be rejected by the admission control unit, the QAP 10 may finally accept the service by suitably modifying the values of some of the TSPEC parameters received by the requesting QSTA 14, provided that the QSTA 14 will accept the modification, as described by the 802.11e specification. That is, the QAP 10 performs a TSPEC negotiation. During the negotiation, the QAP 10 can (theoretically) affect any of the TSPEC parameter values. However, in practice, only protocol-dependent parameter modification should be allowed (e.g., the surplus bandwidth allowance and the minimum PHY rate).

For admission control purposes, the increment of the minimum PHY rate represents the preferred choice for TSPEC negotiation. From the FrameExchangeTime calculation (equation (2)), it is clear that such an increment decreases the FrameExchangeTime value, hence the calculated MediumTime is reduced. The QAP 10 in this case tries to estimate the minimum PHY rate value that would validate either equation of the admission control criteria (equations (7) or (8)). If such a value exists, this value is announced to the requesting QSTA 14 through the AddTS response. It is the responsibility of the QSTA 14 to accept or deny this modification.

AC Re-Negotiation Mechanism

Upon a successful TSPEC negotiation, the corresponding AC is granted time for transmissions equal to the calculated MediumTime per 1 second interval. Due to the statistic nature of the EDCA channel access, the IEEE 802.11e specification describes a basic mechanism for monitoring the actual time employed for transmissions by each AC. More specifically, each QSTA 14 maintains two counters for each of the ACs that require admission control: a) the admitted_time and b) the used_time. Both of the counters are set to zero at the beginning of the QSTA 14 life. Assuming that a TS originally mapped to a specific AC was successfully admitted, the MediumTime calculated by the QAP 10 for that TS is announced to the QSTA 14 and the admitted_time of the corresponding AC is increased by the MediumTime value. Thus, the admitted_time is the aggregated time length within a 1 second interval offered by the QAP to all the admitted TS of an AC that requires admission.

On the other hand, the used_time represents a measurement of the medium occupancy the AC actually achieved within the last 1 second period. More specifically, the QSTA updates the used_time counter value
a) at 1 second intervals as:
   used_{—}time=max(used_{—}time−admitted_{—}time, 0) and (11)
b) after each frame exchange as:
   used_{—}time=used_{—}time+FrameExchangeTime (12)

In typical wireless environments, special transmission conditions (e.g., persistent channel degradation due to near-band interference), may lead to an excessive number of re-transmissions. On the other hand, an admitted traffic source may suddenly produce data bursts not defined in the corresponding TSPEC. Both situations may lead to used_time values greater than the admitted_time. In such a case, the corresponding channel access function should send a request for additional admission time. This process is called AC re-negotiation. Whilst waiting for the response, according to 802.11e, the AC should replace for short time intervals its EDCA parameters with those that correspond to the first lower AC that requires no admission control, in order to send some of the traffic at the admitted priority and some at the unadmitted priority. This procedure is called AC-downgrade.

Controlled AC Renegotiation Mechanism for Enhanced Networking

In accordance with the present invention, a QSTA 14 monitoring mechanism is provided (controlled AC renegotiation mechanism for enhanced networking) for determining whether the bandwidth reservation allocated to a specific AC meets the QoS requirements determined during the TSPEC negotiation. If the QoS performance is lower than the one expected, additional resources are requested through the AC-renegotiation mechanism. On the other hand, if the resources granted to specific traffic are more than those required for QoS transmission, the allocated bandwidth excess is returned back to the QAP 10 using an AC-restoration procedure. The QSTA monitoring mechanism of the present invention takes advantage of the QSTA admission control mechanism, which results in low implementation complexity and hardware requirements.

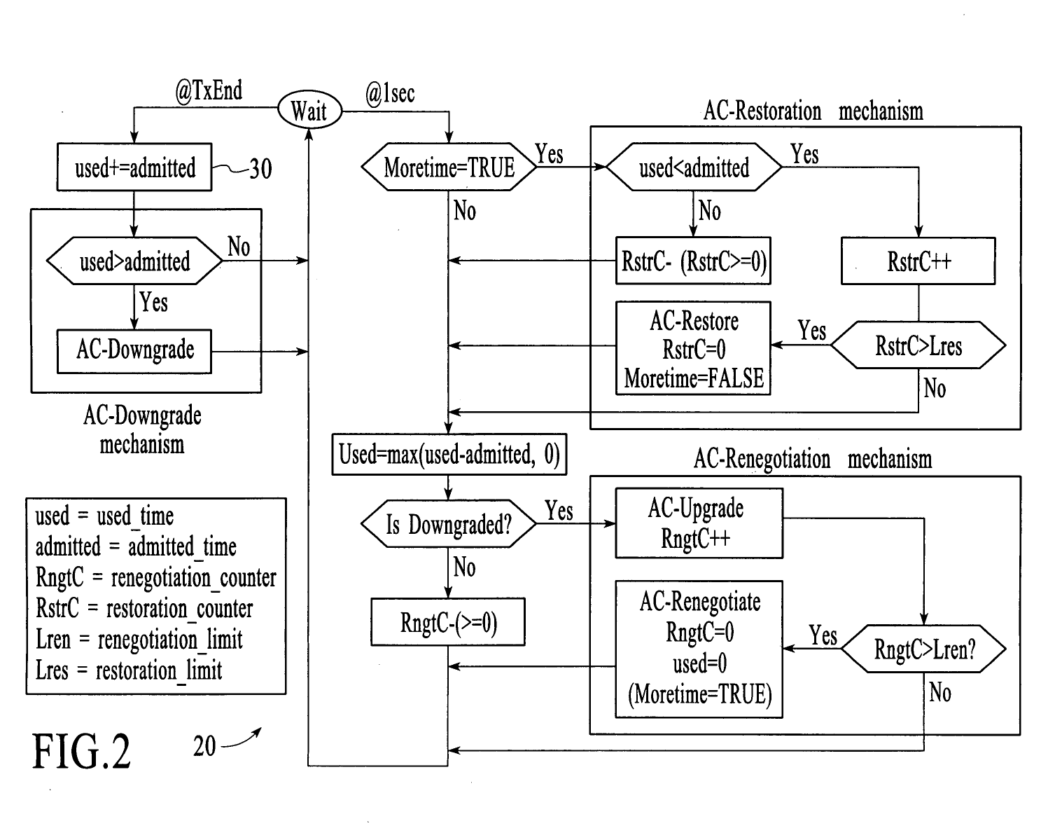

FIG. 2 illustrates a block flow diagram of the QSTA monitoring mechanism 20 in accordance with the present invention. After an AC wireless transmission, if the used_time exceeds the admitted_time value, the corresponding channel access is immediately downgraded and it is directly upgraded, i.e., reloaded with the correct EDCA channel access function parameters, at the next 1 second interval. No AC re-negotiation procedure is initialized until the QSTA 14 determines that the conditions rendered the used_time greater than the admitted_time value are not instant but have a persistent, long-term impact on the achieved QoS performance. This is performed by keeping track of the AC-downgrade occurrences at consecutive 1 second intervals. For this reason, the QSTA 14 maintains a non-negative counter (termed as renegotiation_counter) for each AC, which is initially set to zero and increased by one at 1 second intervals if the AC is downgraded, otherwise it is decreased by one. At each 1 second interval, if the renegotiation_counter value exceeds a specific renegotiation threshold value (termed as renegotiation_limit), the QSTA 14 may request additional admission time from the HC for the corresponding AC.

The selection of the renegotiation_limit value is critical as it represents a trade-off between the safe determination of the persistency of the condition changes that introduce additional medium access requirements (large values) and the fast adaptation of the medium occupancy by the admitted traffic (short values). For example, if renegotiation_limit=4 and under persistent channel degradation, an admitted TSPEC may request additional admission time after a 4 second period.

On the other hand, assume that, due to persistent channel degradation, an AC was granted additional admission time but, when the channel degradation ends, the additional admission time is no longer needed and has to be returned to the HC for future admissions. According to the present invention, this AC-restoration is performed only if the QSTA 14 determines that the bandwidth excess is constantly not employed for AC transmissions in the same way that the AC-renegotiation does. More specifically, each AC maintains the restoration_counter non-negative integer variable. Provided that the AC was granted additional time, the restoration_counter is increased by one at each 1 second interval if the used_time is lower than the admitted_time, otherwise it is decreased by one. If restoration_counter is greater than a specific programmable limit (restoration_counter>restoration_limit), then an AC-restoration procedure is performed by sending an AddTS request.

In order to calculate the additional admission time required for a specific AC, the total required time (in seconds) is firstly estimated in accordance with the present invention by the QSTA 14 according to:
required_{—}time=[admitted_{—}time/LastDowngradeInstance]*1 second (13)
where LastDowngradeInstance is the exact time instance of the last AC-downgrade (measured within a 1 second period), i.e., the time interval during which the AC used all the admitted_time for transmissions. This calculation provides a very accurate approximation of the new traffic conditions for the AC. The additional time to request is derived as:
additional_{—}time=required_{—}time−admitted_{—}time (14)

After the additional_time calculation, the present invention defines the manner in which the appropriate TSPEC parameters included in the AddTS request should be calculated, taking into account that the MediumTime derived by the QAP 10 using the TSPEC must be equal to the requesting additional_time plus the current admitted_time value. Provided that not all the TSPEC parameters may be affected/altered by non-application layers, the TSPEC parameters modification must be limited to the surplus bandwidth allowance factor (SBA). More specifically, if SBA is the current surplus bandwidth allowance value of a TS TSPEC selected by the QSTA 14 that will be used for AC-renegotiation, the modified value SBA′ is represented by:
SBA′=[1+additional_{—}time/admitted_{—}time]*SBA (15)
where admitted_time denotes the time admitted to the specific TSPEC during the last successful AddTS request. Accordingly, during the AC-restoration, the SBA′ must be calculated by:
SBA′=[1−additional_{—}time/admitted_{—}time]*SBA (16)
where admitted_time is the admission time currently granted to the specific TSPEC and additional_time is the amount of the admission time to offer back to the QAP 10.

Although the present invention has been described in accordance with the embodiments shown, one of ordinary skill in the art will readily recognize that there could be variations to the embodiments and those variations would be within the spirit and scope of the present invention. For example, although the present invention has been described in the context of the 802.11 standard, one of ordinary skill in the art readily recognizes that the present invention could be utilized in a variety of wireless environments. Accordingly, many modifications may be made by one of ordinary skill in the art without departing from the spirit and scope of the appended claims.

What is claimed is:

1. A method for a quality of service mechanism for a wireless network, the method comprising:
providing an admission control policy for a quality of service access point (QAP) to manage bandwidth by accepting or denying service to admitted traffic streams of quality of service stations (QSTAs); and
renegotiating different access category parameters in the QAP for enhancing performance in the wireless network.

2. The method of claim 1 wherein providing an admission control policy further comprises calculating a medium occupancy factor, and accepting a traffic stream requesting service when the calculated medium occupancy factor and a medium time value of the traffic stream requesting service is less than a programmable threshold.

3. The method of claim 2 wherein calculating a medium occupancy factor further comprises calculating a medium occupancy factor for all admitted traffic streams.

4. The method of claim 2 wherein calculating a medium occupancy factor further comprises calculating a medium occupancy factor for all access categories that require admission control.

5. The method of claim 2 wherein renegotiating further comprises renegotiating access category parameters of traffic streams that have been denied service.

6. The method of claim 5 wherein renegotiating further comprises recalculating traffic stream parameters of the traffic stream that has been denied service to meet the programmable threshold.

7. The method of claim 6 further comprising providing a response message with the recalculated traffic stream parameters.

8. The method of 1 further comprising providing a programmable bandwidth reservation factor to ensure bandwidth is available to access categories not requiring admission control.

9. The method of claim 1 utilizing a counter for renegotiation and a counter for restoration in each QSTA for every access category that require admission control to determine when a renegotiation limit and restoration limit have been reached to control whether a request for additional admission time or a return of additional admission time occurs.

10. A system for a quality of service mechanism for a wireless network, the system comprising:
a QBSS (quality of service basic service set), the QBSS including
QSTAs (quality of service stations); and
a QAP (quality of service access point), the QAP providing an admission control policy to manage bandwidth by accepting or denying service to admitted traffic streams of the QSTAs and renegotiating different access category parameters of the QSTAs for enhancing performance of the QBSS.

11. The system of claim 10 wherein the QAP further calculates a medium occupancy factor, and accepts a traffic stream requesting service when the calculated medium occupancy factor and a medium time value of the traffic stream requesting service is less than a programmable threshold.

12. The system of claim 11 wherein the QAP further calculates a medium occupancy factor for all admitted traffic streams.

13. The sytsem of claim 11 wherein the QAP further calculates a medium occupancy factor for all access categories that require admission control.

14. The system of claim 11 wherein the QAP further renegotiates access category parameters of traffic streams that have been denied service.

15. The system of claim 14 wherein the QAP further recalculates traffic stream parameters of the traffic stream that has been denied service to meet the programmable threshold.

16. The system of claim 15 wherein the QAP further provides a response message with the recalculated traffic stream parameters.

17. The system of claim 10 wherein the QAP further provides a programmable bandwidth reservation factor to ensure bandwidth is available to access categories not requiring admission control.

18. The system of claim 10 wherein the QSTAs utilize a counter for renegotiation and a counter for restoration for every access category that require admission control to determine when a renegotiation limit and restoration limit have been reached to control whether a request for additional admission time or a return of additional admission time occurs.

19. A method for a quality of service mechanism for a wireless network, the method comprising:
providing an admission control policy for a quality of service access point (QAP) to manage bandwidth by accepting or denying service to admitted traffic streams of quality of service stations (QSTAs);
renegotiating different access category parameters in the QAP for enhancing performance in the wireless network; and
monitoring for controlled access category renegotiation in the QSTAs for enhanced networking to determine whether bandwidth allocation to a specific access category meets quality of service requirements during the renegotiating.

20. The method of claim 19 wherein monitoring further comprises utilizing a counter for renegotiation and a counter for restoration for every access category that require admission control to determine when a renegotiation limit and restoration limit have been reached to control whether a request for additional admission time or a return of additional admission time occurs.

21. A computer readable medium containing program instructions for a quality of service mechanism for a wireless network, the program instructions for:
providing an admission control policy for a quality of service access point (QAP) to manage bandwidth by accepting or denying service to admitted traffic streams of quality of service stations (QSTAs); and
renegotiating different access category parameters in the QAP for enhancing performance in the wireless network.

22. The computer readable medium of claim 21 wherein providing an admission control policy further comprises calculating a medium occupancy factor, and accepting a traffic stream requesting service when the calculated medium occupancy factor and a medium time value of the traffic stream requesting service is less than a programmable threshold.

23. The computer readable medium of claim 22 wherein calculating a medium occupancy factor further comprises calculating a medium occupancy factor for all admitted traffic streams.

24. The computer readable medium of claim 22 wherein calculating a medium occupancy factor further comprises calculating a medium occupancy factor for all access categories that require admission control.

25. The computer readable medium of claim 22 wherein renegotiating further comprises renegotiating access category parameters of traffic streams that have been denied service.

26. The computer readable medium of claim 25 wherein renegotiating further comprises recalculating traffic stream parameters of the traffic stream that has been denied service to meet the programmable threshold.

27. The computer readable medium of claim 26 further comprising providing a response message with the recalculated traffic stream parameters.

28. The computer readable medium of 21 further comprising providing a programmable bandwidth reservation factor to ensure bandwidth is available to access categories not requiring admission control.

29. The computer readable medium of claim 21 utilizing a counter for renegotiation and a counter for restoration in each QSTA for every access category that require admission control to determine when a renegotiation limit and restoration limit have been reached to control whether a request for additional admission time or a return of additional admission time occurs.
